(19) United States
(12) Patent Application Publication
(10) Pub. No.: US 2026/0311192 A1
(43) Pub. Date: Oct. 8, 2026

(54) TECHNIQUES FOR DYNAMIC COMPLIANCE MONITORING AND ANALYSIS

(71) Applicant: Anecdotes.ai, LTD, Tel Aviv (IL)

(72) Inventors: Yael DAIHES, Tel Aviv (IL); Lidiya NORMAN, Tel Aviv (IL); Roi AMIOR, Ra'anana (IL)

(73) Assignee: Anecdotes.ai, LTD, Tel Aviv (IL)

(21) Appl. No.: 19/171,626

(22) Filed: Apr. 7, 2025

(51) Int. Cl. G06Q 30/018; G06F 16/245

(52) U.S. Cl. CPC G06Q 30/018; G06F 16/245

(57) ABSTRACT

A system and method for dynamic monitoring of compliance with an organization policy is presented. The method includes searching a datastore for a group of evidence data based on a search query of a definitive statement, wherein the group of evidence data has unstructured evidence data relevant to the definitive statement, wherein the definitive statement is from the organization policy; applying a query model to determine a compliance query for the group of evidence data, wherein the compliance query is a context-based query that is unique to the group of evidence data and the definitive statement; querying the group of evidence data using the determined compliance query; and determining a compliance status with the definitive statement of the organization policy based on the query.

### TECHNICAL FIELD

The present disclosure relates generally to policy compliance, particularly for automatic querying and processing of unstructured evidence data using artificial intelligence (AI) models.

### BACKGROUND

Government, Risk, and Compliance (GRC) strategy is adopted and integrated in many organizations, big and small, in order to achieve organization objectives. Here, compliance indicates the organization's compliance with requirements of internal and/or external guidelines, also referred to as frameworks. External frameworks are widely accepted guidelines or standards that are established by external organizations for individuals, organizations, or the like to adhere to, in order to protect data that are handled and utilized. Common frameworks include, for example, but not limited to, Security and Compliance Standard (SOC), Health Insurance Portability and Accountability Act (HIPAA), Payment Card Industry Data Security Standard (PCI DSS), and the like. Stakeholders may leverage such frameworks to gauge the validity and/or security of the organization. Incompliance with frameworks can lead to adverse effects such as financial penalties, loss of operating licenses, investigations, and more.

In addition to external frameworks, internal frameworks that outline general policies across an organization (or a company) may be generated and tracked for compliance. These policies describe the organization's various objectives ranging from security policies, attendance policies, and more. It has been identified that whether internal or external, frameworks are important to track and often strenuous to effectively examine, track, keep on top off the compliance or execution.

Thus, compliance with present and future processes, as well as activities to address such compliance requirements may be key features for the maintenance and healthy growth of the organization. Organizations can implement compliance programs that include tools, strategies, and the like, to ensure compliance at different stages and with frameworks. Based on their business sector, the organization may be more concerned with one framework over another. In many cases, organizations may be concerned about the organization's compliance with one or more frameworks.

It has been identified that evidences may be collected from all parts of the organization to determine compliance. Evidences are data or documents such as, but not limited to, policies, manuals, standard operation procedures, regulatory mandates, training records, and the like, and more that suggest a compliance state (or posture) of the organization. To this end, the evidence data are collected and stored in vastly different data types and formats.

Currently implemented techniques often rely on manual pulling of evidences, which are limited to isolated auditing and checking off of boxes in a list of audit requirements. The technique is manually performed at a specific time of need (e.g., before an audit, at reporting season, and the like). The static nature of the current techniques does not capture the ever-changing, exponential growth of the organization within and in relation to third-party entities. That is, compliance analyses and postures determined using currently implemented techniques may be limited in scope and out of date to provide inaccurate analyses of the organization's compliance.

The evidence data collected for compliance analysis for external frameworks may also be realized for determining compliance to internal frameworks, i.e., an organization or company policy. However, searching for relevant evidence data is challenging due to the unstructured nature of the evidence data. Moreover, continuous monitoring of such large amount of data creates computational overload and challenges.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for dynamic monitoring of compliance with an organization policy. The method comprises: searching a datastore for a group of evidence data based on a search query of a definitive statement, wherein the group of evidence data has unstructured evidence data relevant to the definitive statement, wherein the definitive statement is from the organization policy; applying a query model to determine a compliance query for the group of evidence data, wherein the compliance query is a context-based query that is unique to the group of evidence data and the definitive statement; querying the group of evidence data using the determined compliance query; and determining a compliance status with the definitive statement of the organization policy based on the query.

Certain embodiments disclosed herein also include a non-transitory computer readable medium having stored thereon causing a processing circuitry to execute a process, the process comprising: searching a datastore for a group of evidence data based on a search query of a definitive statement, wherein the group of evidence data has unstructured evidence data relevant to the definitive statement, wherein the definitive statement is from the organization policy; applying a query model to determine a compliance query for the group of evidence data, wherein the compliance query is a context-based query that is unique to the group of evidence data and the definitive statement; querying the group of evidence data using the determined compliance query; and determining a compliance status with the definitive statement of the organization policy based on the query.

Certain embodiments disclosed herein also include a system for dynamic monitoring of compliance with an organization policy. The system comprises: a processing circuitry; and a memory, the memory containing instructions that, when executed by the processing circuitry, configure the system to: search a datastore for a group of evidence data based on a search query of a definitive statement, wherein the group of evidence data has unstructured evidence data relevant to the definitive statement, wherein the definitive statement is from the organization policy; apply a query model to determine a compliance query for the group of evidence data, wherein the compliance query is a context-based query that is unique to the group of evidence data and the definitive statement; query the group of evidence data using the determined compliance query; and determine a compliance status with the definitive statement of the organization policy based on the query.

Certain embodiments disclosed herein include the method, non-transitory computer readable medium, or system noted above or below, further including or being configured to perform the following step or steps: causing a display of the determined compliance status at a user device.

Certain embodiments disclosed herein include the method, non-transitory computer readable medium, or system noted above, wherein the display is a notification that has the determined compliance status and the definitive statement.

Certain embodiments disclosed herein include the method, non-transitory computer readable medium, or system noted above or below, further including or being configured to perform the following step or steps: identifying the definitive statement from the organization policy by applying a policy language model to the organization policy, wherein the organization policy and the definitive statement is in a natural language.

Certain embodiments disclosed herein include the method, non-transitory computer readable medium, or system noted above or below, further including or being configured to perform the following step or steps: generating a compliance prompt to be fed to the query model. wherein the compliance prompt has a definitive statement, a group of evidence data, context, and examples.

Certain embodiments disclosed herein include the method, non-transitory computer readable medium, or system noted above or below, further including or being configured to perform the following step or steps: automatically retrieving the organization policy from the datastore, wherein the retrieving is initiated by at least one of: a periodical time interval, a demand, and a trigger.

Certain embodiments disclosed herein include the method, non-transitory computer readable medium, or system noted above, wherein the compliance status is any one of: a gap and a compliance.

Certain embodiments disclosed herein include the method, non-transitory computer readable medium, or system noted above or below, further including or being configured to perform the following step or steps: applying the query model to determine the search query based on a search prompt that has the definitive statement, context, and example, wherein the search query is a context-based query that is specific to the definitive statement.

Certain embodiments disclosed herein include the method, non-transitory computer readable medium, or system noted above, wherein the query model is any one of: a general language model, a fine-tuned language model, a domain-specific language model, and a task-specific language model.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for dynamic compliance monitoring according to an embodiment.

FIG. 3 is a flowchart illustrating a method for identifying a definitive statement according to an embodiment.

FIG. 4 is a flowchart illustrating a method for determining a compliance query by applying a query model according to an embodiment.

FIG. 5 is a schematic diagram of a compliance system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for dynamically monitoring an organization and its user systems for compliance with an organization policy (i.e., an internal framework). The organization policy is a natural language document that describes various controls or guidelines that are set for the organization to abide by. The embodiments disclosed herein apply at least one language model to read and monitor the organization policy and to automatically detect compliance with the policy based on evidence data stored at the datastores. Moreover, a context-based query language is utilized in order to search and retrieve unstructured and/or semi-structured evidence data that are stored in varied formats at a plurality of datastores. It should be noted that the disclosed embodiments enable automatic reading and compliance analysis with respect to the organization policy without manual intervention. Moreover, the accurate context-based query for evidence data improves the search, retrieval, and compliance analysis as a whole for the organization, which are advantageous for any compliance-related activities which are directly related to the security and operation of the organization.

The embodiments disclosed herein provide automatic monitoring of compliance with the organization policy. In particular, any updates or changes in the policy are detected regularly (e.g., continuously, intermittently, or both) to maintain the organization's conformity to its own standard procedures and controls as described in the policy. At least one language model of varied size may be applied to read and analyze (e.g., semantically, syntactically, etc.) the policy document to identify various controls, predetermined, new, or both. The language model may be input with a specified prompt for effective determination of controls (i.e., standards or guidelines) in the policy.

Moreover, the continuous analysis allows compliance analysis using current evidence data rather than outdated data. That is, the embodiments disclosed herein monitors and determined policy compliance using latest policy controls and recent evidence data that reflects the current state of the organization. The automatic monitoring ensures continuous management and up-to-date conformity to reduce operation and security risks from oversights.

Commonly, compliance-related evidence data may be in various data types such as, but not limited to, images, screenshots, logs, text, and the like, and any combination thereof. For efficient collection and storage, such evidence data are often stored as raw data or normalized in such a way to reflect a control of a specific framework. The format or arrangement of normalized data tables may vary greatly based on, for example, collection time, collection system or application, parser, computing resource, computing platform, auditing software, and the like, and any combination thereof, resulting in inconsistent structural formats between data tables. However, such evidence data may be used as evidence or support for numerous controls associated with different internal or external frameworks without being limited to one control.

The embodiments disclosed herein provide a method to efficiently and accurately query the datastore with evidence data tables in varied formats for relevant evidence data. Specifically, a context-based query language is realized to search the data tables for the semantic context that are otherwise not possible using conventional query languages.

According to the disclosed embodiments, a specified prompt may include input text (e.g., definitive statement, relevant paragraph of the policy, group of evidence data, etc.), background context (e.g., instructions, examples, etc.), query language guidelines, and the like, and any combination thereof. At least one language model is applied to the specified prompt to output a unique query for the definitive statement and the group of evidence data for accurate and efficient search and retrieval. Moreover, unique query is agnostic to datastore schema and the source of the evidence data for flexible analysis of compliance. It should be noted that such flexibility is crucial for analyzing framework and/or policy compliance due to evidence data complexity and variability.

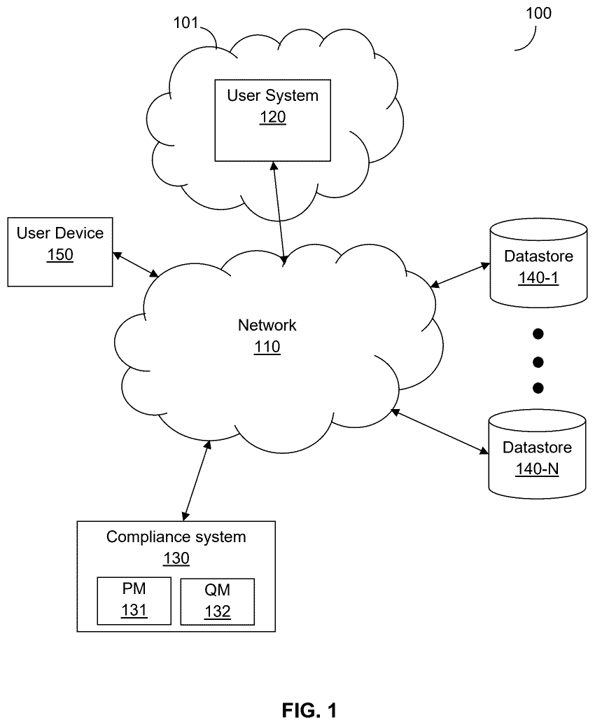

FIG. 1 shows an example network diagram 100 utilized to describe the various disclosed embodiments. In the example network diagram 100, a user system 120, a compliance system 130, a plurality of datastores 140 (hereinafter referred to individually as a datastore 140 and collectively as datastores 140, merely for simplicity purposes, and wherein N is an integer greater than 1), and the user device 150 communicate via a network 110. The network 110 may be, but is not limited to, a wireless, cellular or wired network, a local area network (LAN), a wide area network (WAN), a metro area network (MAN), the Internet, the world wide web (WWW), similar networks, and any combination thereof.

In an embodiment, the user system 120 is deployed at the cloud computing platform 101, for example, at an organization-side (or user side). In some configurations, the cloud computing platform 101 may include one or more datastores 140. The cloud computing platform 101 may be, but is not limited to, a public cloud, a private cloud, or a hybrid cloud and may be cloud computing platforms of, for example, but not limited to, Amazon® Web Services (AWS), Cisco® Metacloud, Microsoft® Azure®, Google® Cloud Platform (GCP), and the like.

The user system 120 may be a component, a server, a system, a device, an infrastructure, or the like. The user system 120 may be deployed with one or more plugins (e.g., service, application, etc.), which are referred to as integrations. The plugin may be a software component that operates to provide, for example, but not limited to, cloud infrastructure, development tools, organizational tools, identity providers, human resource tools, security tools, and the like, and more. The plugin may be accessed via an Application Programming Interface (API). Each plugin in the user system 120 includes a plurality of evidences of compliance (or simply referred to as evidences or evidence data herein) as raw data that may be collected and stored at the datastores 140. The term user system may be used herein to refer to the user system 120 as a whole, as well as the plugins deployed at the user system 120.

It should be noted that although one user system 120 is depicted in FIG. 1, merely for the sake of simplicity, the embodiments disclosed herein may be applied to a plurality of user systems that are associated with a same entity, different entities, or both. The user system 120 may be deployed in a cloud environment such as a private cloud, a public cloud, or a hybrid cloud. The compliance system 130 is configured to communicate with the plurality of user systems 120 as separate instances, for example, per user entity, per system, per account, and the like. The compliance system 130 processed the evidence data with respect to an organization policy to determine a compliance status of the user system 120.

In some implementations, an agent that is realized as a piece of code may be run in one or more resources of the cloud computing platform 101 to monitor changes in, for example, the organization policy, evidence data collection, or the like, and any combination thereof.

The datastores 140 may be data repositories storing data such as, but not limited to, raw evidence data, normalized evidence data, evidence data tables, and the like, and any combination thereof. The evidence data (e.g., raw evidence data, normalized evidence data, etc.) are evidences of compliance that are collected and/or processed at the compliance system 130 and subsequently stored at the datastores 140. The evidences are data and/or documents that are relevant to framework compliance and include, for example, but not limited to, policies, standard operation procedures, audit trails and logs, training records, incident response plans, change management policies, risk assessment, third-party agreements, user system 120 (or plugin) configuration, and the like, and any combination thereof of the user system 120 and/or its integrated plugins.

In an embodiment, the evidence data may be collected and organized as data tables with respect to external framework such as, but not limited to, Security and Compliance Standard (SOC), Health Insurance Portability and Accountability Act (HIPAA), and more. Such data tables are a collection of unstructured and/or semi-structured evidence data that are collected from the user system 120 via one or more plugins. It should be noted that such evidence data include supporting information and support for the organization policy as well. To this end, additional collection of evidence data from the user system 120 is avoided to reduce network traffic, processing power, and storage space and costs.

Additionally, the datastore 140 may be configured to store the organization policy. The organization policy includes various guidelines, standards, and specific procedures or practices for which the organization has established to conform to. As noted, the guidelines of the organization policy may overlap with the guidelines of one or more external frameworks. In an example embodiment, the organization policy document may be manually or automatically uploaded to the datastore 140. In another example embodiment, a link to the policy document may be stored to enable periodic or on-demand updating of the policy document, automatically. In yet another example embodiment, the organization policy may be established based on verified evidence data stored within the datastore 140. It should be noted that the datastore 140 with the organization policy may be same or different from the datastores 140 storing the evidence data.

The datastores 140 may be deployed at one or more cloud computing platforms. Moreover, the datastores 140 may be distributed with portions deployed at, for example, the same user-side cloud computing platform 101, the cloud computing platform of the compliance system 130, an entirely separate cloud computing platform, and any combination thereof. In an example embodiment, the datastores may be running in the same cloud computing platform, but at different geographical locations. In an embodiment, the datastores 140 may be managed by a user entity (or owner) of the user system 120 and the organization. As an example, the configurations, locations, access, credentials and the like, may be carefully managed by the user entity. In some implementations, operations to read from and/or write to the datastores 140 may be controlled by an authentication and authorization process for security of stored data.

In some embodiments, the datastores 140 may store application programming interface (API) keys, which are credentials or identifiers to authenticate and authorize access to, for example, and without limitations, the user system 120, its integrated plugins (e.g., services, application, etc.), and the like, over an application programming interface (API). In some cases, the datastore 140 may be designated to store API keys without evidence data.

The compliance system 130 is a component, a server, a device, a system, or the like configured to query the datastore 140 for evidence data and determine compliance of the user system 120 (or the whole organization infrastructure) with the organization policy. The compliance system 130 receives the organization policy, from the datastore 140, which is processed to determine specific controls (i.e., standards, guidelines, etc.) and associated practical procedures or practices. Moreover, the compliance system 130 queries the datastores to detect supporting evidence data for the specific controls and perform compliance analyses.

The evidences may be data and/or documents that are relevant to framework compliance and include, for example, but not limited to, policies, standard operation procedures, audit trails and logs, training records, incident response plans, change management policies, risk assessment, third-party agreements, user system 120 (or plugin) configuration, and the like, and any combination thereof. The raw data of evidence may be unstructured or semi-structured data such as, but not limited to, screenshots, text documents, multimedia files, logs, calendars, and the like, and any combination thereof. The raw data of evidences collected for the user system 120 may be associated with metadata such as, but not limited to, user name or identifier (ID), instance ID, user system ID, collection time, description, compliance test result (e.g., success or failure), and the like and stored in the datastore 140. The raw evidence data may be arranged as data tables (i.e., normalized data) and given an evidence identifier (ID). It should be noted that such data tables organize the unstructured evidence data without relying on schema-based structures and may be in varied formats.

According to the disclosed embodiments, the compliance system 130 may be configured with a policy model (PM) 131 and a query model (QM) 132. The policy model 131 and the query model 132 may be language models that are realized for specific operations with or without training. The language models may be, for example, but not limited to, generative pre-trained transformers (GPT-3, GPT-4, GPT-4o, etc.), bidirectional encoder representation (BERT), text-to-text-transfer transformer (T5), XLNet, Pathways Language Model (PaLM), Embeddings from Language Models (ELMo), Large Language Model Metal AI (Llama), Gemini, Granite, Megatron, and more.

The policy model 131 is configured to determine a definitive statement for a control from the organization policy document in the natural language. A policy document describes various aspects of the controls that the organization desired to protect. For example, the policy document may include sections such as, but not limited to, background, code of conduct, procedures, future work, terms and conditions, and the like, and any combination thereof for a control. The policy model 131 is configured to process the policy document to determine the definitive statement that describes how the control can be fulfilled. That is, the definitive statement describes an actionable and monitorable practice in order to detect compliance with the corresponding control of the organization's policy. An actionable practice can be acted upon or has concrete steps to take. A monitorable practice is a process or action that results in data points that can be logged and tracked.

In an embodiment, the policy model 131 applies at least a language model to the policy document to identify and determine the definitive statement from the policy document. The language model may be, for example, but not limited to, a general language model, a fine-tuned language model, task-specific language model, domain-specific language model, or the like. In an example embodiment, the example dataset and/or instructions may be prompt to the general language model. In some implementations, the query model 132 may be employed to generate a statement query to feed the language model and identify the definitive statement. In another example embodiment, the language model may be trained using the example dataset. The example dataset may be relevant to, for example, but not limited to, a company, a domain, a task, and the like, and any combination thereof.

The query model 132 is configured to generate a context-based query for searching and processing the unstructured evidence data for effective compliance analysis. The context-based query is a query that defines the context of the requested data without schema linking. In an embodiment, at least one language model is applied to a specified prompt to generate the unique context-based query for the specified prompt. In a further embodiment, the output context-based query may be written in a non-schema-based query language to request information for, for example, the datastore 140. The query language model may be, for example, but not limited to, a general language model, a specifically trained language model, a fine-tuned language model, or the like. A single query model 132 is shown in the network diagram 100 for illustration and does not limit the scope of the disclosure. The compliance system 130 may be configured with one or more query models.

In an embodiment, query model 132 is configured to generate a search query from the definitive statement identified from the policy model 131. A search prompt may include, for example, but not limited to, a relevant paragraph including the definitive statement, a definitive statement, query language guidelines, instruction, background context, examples, and the like, and any combination thereof and is fed to the query model 132 to generate the search query. The search query is employed to search the unstructured datastore 140 for evidence data that is relevant to the definitive statement. The query language guideline has instructions to generate a query that does not rely on the datastore schema directly. In an embodiment, the search may result in one or more groups of evidence data (e.g., evidence data tables) that are arranged together in varied formats. The group of evidence data may be associated with metadata. It should be noted that the search query allows efficient and flexible searching of the datastore 140 that is agnostic to schema and the systems.

Additionally, the query model 132 is configured to generate a compliance query based on the definitive statement and the groups of evidence data. The query model 132 is input a compliance prompt that has, for example, but not limited to, the definitive statement, the group of evidence data, the query language guidelines, instruction, background, context, examples (e.g., positive, negative, or both), and the like, and any combination thereof. It should be noted that the compliance query is unique to the compliance prompt and thus, may be different for each of the group of evidence data even for the same definitive statement.

Moreover, the compliance system 130 is configured to determine a compliance status for the user system 120 based on the retrieved evidence data from the datastore 140. Specifically, the compliance status is determined by querying the datastore 140 and the group of evidence data according to the customized queries of the query model 132. The customized queries allow rapid contextual searching and processing of evidence data that may be various formats. It should be noted that such search cannot readily be performed without the systematic context-based querying as disclosed herein. The compliance status is determined from the current organization policy and evidence data to reflect an accurate determination of compliance. It should be appreciated that such continuous monitoring of current compliance enables efficient compliance management and maintenance.

The user device 150 may be, but is not limited to, a personal computer, a laptop, a tablet computer, a smartphone, a wearable computing device, or any other device capable of receiving and displaying notifications. The user device 150 may be accessed by a user of the organization. The notification may include, for example, but not limited to, at least a portion of the organization policy, a definitive statement, an indication of compliance status (e.g., a symbol, a color, a statement, a score, a percentage, and the like), a list of evidence data, and the like, and any combination thereof. In some cases, an alert may be generated and caused to be displayed at the user device 150 when incompliance is determined. In an embodiment, a graphical user interface (GUI) may be utilized to display the notification and for the user to interact with.

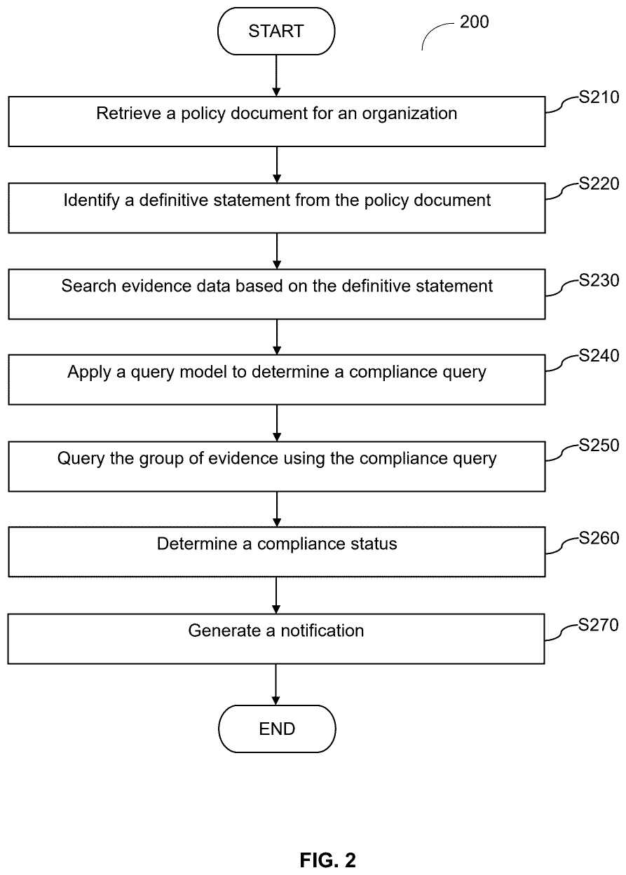

FIG. 2 is an example flowchart 200 illustrating a method for dynamically monitoring compliance with a company (or organization) policy according to an embodiment. It should be noted that the method is described with respect to a definitive statement describing a control for simplicity. However, more than one controls and definitive statements may be identified during the dynamic monitoring for the method to be simultaneously performed for multiple controls and definitive statements in the policy of the organization associated with the user system 120. The method described herein is performed in the compliance system 130 including at least a policy model 131 and a query model 132, FIG. 1. The compliance system 130 collects raw and/or normalized evidence data from the datastores 140.

At S210, a policy of an organization is retrieved. The policy of the organization associated with the user is retrieved from the user system and/or datastore of the user (e.g., the user system 120 and the datastores 140, FIG. 1). The policy is retrieved as a document represented in the natural language. In an embodiment, the policy may be retrieved upon detecting an update and/or change in the policy. In an embodiment, the policy may be retrieved from datastore with a trigger such as, but not limited to, an update of the policy document, an upload of the policy document, a new policy document, and the like. In another embodiment, the policy may leverage the verified evidence data stored in the datastore. The policy may be retrieved at, for example and without limitation, periodical time intervals, on-demand, a trigger, or any combination thereof. As an example, the policy may be retrieved weekly.

At S220, a definitive statement describing a control is identified. The definitive statement is a natural language excerpt from the policy document indicating a requirement to satisfy a control (or guideline) in the policy. As an example, a definitive statement “A multifactor authentication must be set-up for all users” may be identified for a control that describes importance of authentication, multifactor authentication, secured access into all services and/or applications utilized at the user system. The control is a description of a policy and may be presented as in the natural language paragraph forms. In an embodiment, the indexes that define the location of the definitive statement may be identified.

In an embodiment, the control and its definitive statement is identified by applying a language model (e.g., the policy model 131, FIG. 1) to the retrieved policy that is in the natural language. Some examples of the language model may include, without limitation, generative pre-trained transformers (GPT-3, GPT-4, GPT-4o, etc.), bidirectional encoder representation (BERT), text-to-text-transfer transformer (T5), XLNet, Pathways Language Model (PaLM), Embeddings from Language Models (ELMo), Large Language Model Metal AI (Llama), Gemini, Granite, Megatron, and more.

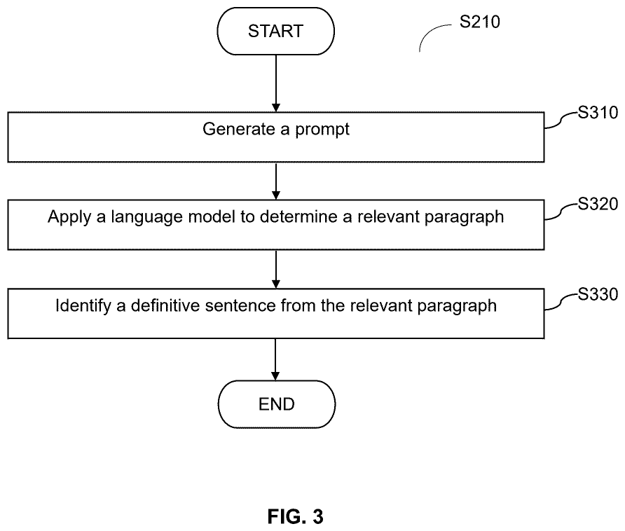

In an embodiment, the language model may be a generally pre-trained language model or large language model (LLM). In another embodiment, the language model may be a specifically trained language model realized by, for example, but not limited to, various organization data, policy data from organizations within the same field, compliance data, and the like, and any combination thereof. In yet another embodiment, the language model may be a fine-tuned language model based on, for example, but not limited to, instruction data, example datasets, and the like, and any combination thereof. An example dataset may include, without limitation, organization data, background data, policy data, and the like, and more. The method of identifying the definitive statement from the policy is further described in FIG. 3. In some cases, a predetermined definitive statement may be used when the organization policy has not changed.

At S230, evidence data is searched based on the definitive statement. The search is performed to retrieve one or more groups of evidence data that are relevant to the identified definitive statement, as outlines in a search query. In an embodiment, at least one language model (e.g., the query model 132, FIG. 1) may be applied to generate the search query. A specified search prompt is fed to the language model. In an example embodiment, the specified search prompt is engineered to include, for example, but not limited to, a relevant paragraph including the identified definitive statement, the identified definitive statement, query language guidelines, instruction, background context, examples, and the like, and any combination thereof. The search query is a context-based query that allows searching the datastore (e.g., the datastore 140, FIG. 1) for groups of evidence data according to the context of the definitive statement and the organization.

It should be noted that the context-based query enables the search to map one or more groups of evidence data to the definitive statement that is otherwise not permissible using conventional schema-based query techniques. It should be further noted that the context-based query for different tables of evidence data improves accuracy and speed at which the datastores are searched.

As noted above, the evidence data may be unstructured or semi-structured data collected from the user system (e.g., the user system 120, FIG. 1) and stored at the datastores at various times. Such evidence data may be collected from the user system for various users (e.g., employees) within the organization, applications, services, and the like, associated with the user system.

In some embodiments, the raw evidence data that are collected may be processed and stored as normalized data to reflect a guideline of an external framework. Such normalized data may again arrange the unstructured data in various formats without consistency between different data tables. The group of evidence data (e.g., the data table) may be grouped based on, for example, but not limited to, description, collection time, plugin of the user system, user system, application, and the like, and any combination thereof. The evidence data are collected continuously, intermittently, or both to service as the evidence data for various frameworks which may include external frameworks (e.g., SOC, etc.) as well as internal frameworks (i.e., organization's policy).

It should be noted that the search retrieves selected groups of evidence data in order to shift the evidence data that is associated with the identified definitive statement from all evidence data stored in the datastores (e.g., the datastores 140, FIG. 1). The context-based query is not only efficient, but it also reduces the amount of evidence data to be processed, thereby reducing computational burden at, for example, the datastores and the compliance system.

At S240, a query model is applied in order to determine a compliance query with respect to the identified definitive statement. The query model is applied to the group of evidence data (S230) and definitive statement (S220) that are determined. Here, a compliance prompt includes, for example, but not limited to, the identified definitive statement, the group of evidence data, the query language guidelines, instruction, background, context, examples (e.g., positive, negative, or both), and the like, and any combination thereof. The query model is applied to the compliance prompt. It should be noted that the evidence data are unstructured data such as, but not limited to, screenshots, text documents, multimedia files, logs, calendars, and the like, and any combination thereof, that are collected from the user system (e.g., the user system 120, FIG. 1). It should be noted that the context of the prompt is dynamic and changes based on, for example, but not limited to, the definitive statement, the group of evidence data, the organization, and the like, and any combination thereof. Thus, the generated query is also not static and dynamic based on the identified definitive statement and the searched groups of evidence data.

At least one trained language model (e.g., the query model 132, FIG. 1) may be applied to create the compliance query based on the control-relevant paragraph and definitive statement. In an embodiment, the trained language model may be a specifically trained language model that is fine-tuned using specific language of compliance and policies of the organization. In another embodiment, the trained language model may be a generally trained language model that is provided with sufficient background information and descriptions to generate an accurate query.

As noted above, the determined compliance query reflects the context for search and retrieval of unstructured evidence data arranged in groups without schema-linking. That is, the search query is generated by applying unstructured data (e.g., definitive statement, groups of evidence data) to query and further process unstructured data (e.g., evidence data) for compliance analysis. Such analysis is enabled by the search and compliance queries as disclosed. In an embodiment, the language model (e.g., the query model 132, FIG. 1) for determining the search query and the compliance query may be same or different. In an embodiment, the process of generating a compliance query may be similarly applied to a search query by applying the language model to a different prompt engineering for the search query as described in S230.

In another embodiment, the query is determined from existing queries for the identified definitive statement. In some embodiments, the query may include rules such as, but not limited to, evidence identifier (ID), criteria, and the like, and any combination thereof in order to search for and retrieve the evidence data stored at the datastores (e.g., the datastores 140, FIG. 1) that supports the identified statement. The evidence ID may be associated with a data table or a group including a collection of unstructured evidence data. That is, the query and its rules are defined to represent the semantic meaning of the definitive statement. The rules in the query may be different for each group of evidence data for the same definitive statement.

At S250, a group of evidence data are queried using the compliance query. The querying identifies whether the evidence data in the group of evidence data satisfies the criteria of the compliance query. The evidence data identified from the query supports and serves as proof of fulfilling the practice defined in the definitive statement. For example, if the definitive statement states “A multifactor authentication must be set-up for all users,” each evidence data that are retrieved from the query is a proof that a multifactor authentication is set-up for a user. As noted above, the compliance query is performed on the selected (or sifted) groups of the evidence data.

At S260, a compliance status with the definitive statement of the policy is determined. The compliance status to the definitive statement and its control is determined from querying the retrieved group of evidence data. The compliance status is determined as a “gap” upon identifying an evidence data, or a row of evidence data, which does not satisfy the query and thus, the criteria for compliance. In an embodiment, the compliance status may be output as a Boolean data type indicating compliance or incompliance with the definitive statement. In another implementation, a number or percentage of evidence data above a predetermined threshold value may be utilized to determine the compliance status.

At S270, a notification is generated. The notification has the compliance status of the user system and/or organization as a whole with respect to the control (and identified definitive statement) described in the organization policy. In addition, the notification may include a list of evidence data that supports the definitive statement and is retrieved from the datastore. In an example embodiment, an alert may be generated for an incompliant control to be followed by a security measure. It should be appreciated that the dynamic monitoring of compliance allows rapid, even immediate, responses or maintenance of incompliances to reduce risks and promote healthy growth of the organization.

In an embodiment, the generated notification is caused to be displayed at a user device (e.g., the user device 150, FIG. 1). In a further embodiment, the generated notification may be presented via a graphical user interface (GUI) for display and interaction with a user (e.g., an employee) of the organization. It should be noted that the notification is displayed so that a user understands the compliance status and the evidences, for example and without limitation, in the natural language, in colors, as symbols (e.g., check marks, x marks, etc.), and the like, and any combination thereof.

As an example, the GUI may display at least a portion of the organization policy document including the definitive statement as well as an indicator of compliance status and a list of evidences extracted from the evidence data. In another example, the GUI may display a portion of the organization policy document including the definitive statement along with an incompliant symbol and a pop-up notification.

FIG. 3 is an example flowchart S220 illustrating a method for identifying a definitive statement according to an embodiment. The method described herein may be performed in the compliance system 130 deployed with a policy model 131, FIG. 1. In an embodiment, the policy model is a language model such as, but not limited to, a general language model, a fine-tuned language model, a specifically trained language model, or the like, of varied sizes (e.g., small, large, etc.).

The method describes the identification of one definitive statement from the policy document for simplicity. One or ordinary skill in the art would understand that multiple definitive statements may be identified simultaneously from a policy document of the organization. A policy document describes and lays out various controls (or guidelines) related to, for example, but not limited to, operations, security, code of conduct, workplace environment, privacy and confidentiality, and the like, and more.

At S310, a prompt is generated. The generated prompt includes the retrieved policy document in the natural language as the input text. In addition, the prompt includes a task, a background, an output format, and the like, to be provided to a language model. In an embodiment, the prompt may include instructions and/or example datasets of the definitive statements to be identified. For example, the prompt may include data that show actionable and/or monitorable statements for identification. In another example, the prompt may include, for example, but not limited to, organization-specific, technology-specific, concept-specific data, and the like, and any combination thereof. In an embodiment, the prompt and its various components may be dynamically generated according to, for example, the user system, the organization, the policy document, and the like, and any combination thereof.

At S320, a language model is applied to the prompt to determine a paragraph that is relevant to a control of the organization's policy. The control of an organization's policy is a guideline or standard that the organization has set to follow or to conform. In an embodiment, the policy language model (e.g., the policy model 131, FIG. 1) is configured to identify a portion of the policy document (e.g., a paragraph or a group of paragraphs) that describes a control of the organization policy. In a further embodiment, a score is determined for each portion of the policy document for different aspects such as, but not limited to, syntax, semantics, and the like. The score defines a likelihood of the portion of the policy document to be relevant to the control of the organization's policy. In an embodiment, the paragraph with the score above a predefined threshold value is determined as a relevant paragraph.

The language model may be a small language model, a large language model, or the like. In an embodiment, the language model may be a pre-trained language model using general natural language data. In another embodiment, the language model may be a specifically trained language model using, for example, but not limited to, compliance data, evidence data, policies, and the like, and any combination thereof, of the specific organization, public, or both. As an example, specific instructions and example datasets may be utilized for training, fine-tuning, or both.

At S330, a definitive sentence is identified from the relevant paragraph. The language model may be further utilized to identify the definitive sentence from the relevant paragraph in the policy. The definitive sentence is an excerpt from the relevant paragraph that defines a specific condition to satisfy the associated control. In an embodiment, the indexes describing the specific location of the definitive sentence in the policy document are identified. In an example embodiment, the definitive statement may describe procedures or guidelines that are actionable, monitorable, or both in relation to the relevant control described in the policy, which are identified based on the prompt of S310.

It should be noted that the direct quotation of the definitive sentence avoids potential hallucination from the language model and ensures accurate representation of the requirements of the policy. It should be further noted that accurate determination and analysis of policy requirements are critical for secure operation and maintenance of the organization.

In some embodiments, the relevant paragraph is matched to a predetermined control based on the semantics and context. The predetermined control is one of the existing controls that are previously determined from, for example, the same organization, the same policy document, or the like. That is, the predetermined controls are known guidelines or standards of the policy or frameworks that are being monitored. By matching the relevant paragraph to the predetermined control, the associated requirements and evidences of the predetermined control may be retrieved and also mapped to the relevant paragraph. In some embodiments, the matching may be performed using the definitive statement identified from the relevant paragraph. In an example embodiment, the match is performed by, for example, but not limited to, similarity measurements of their vector representations.

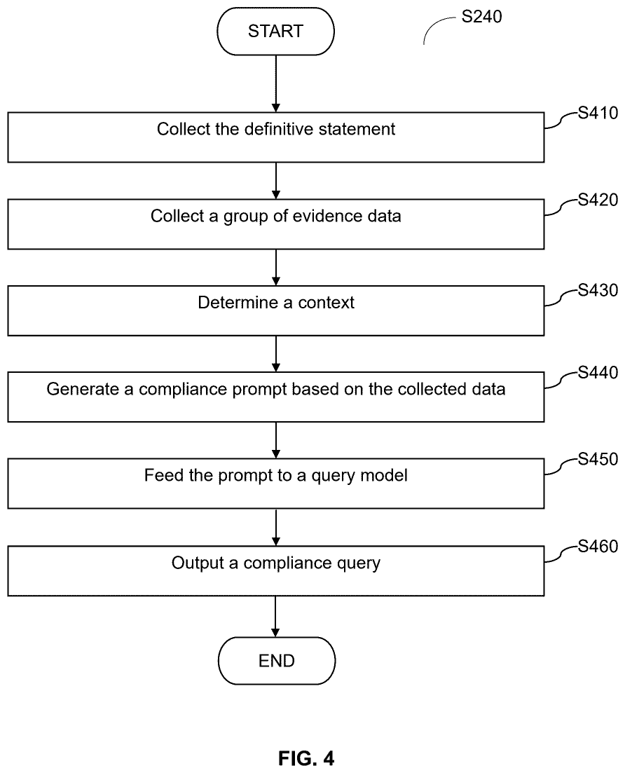

FIG. 4 is an example flowchart S240 illustrating a method for applying a query model to determine a compliance query according to an embodiment. The method described herein may be performed in the compliance system 130 that is deployed with a query model 132. The query model may be at least one language model such as, but not limited to, a generally pre-trained language model, a domain-specific language model, a task-specific language model, a fine-tuned language model, or the like.

At S410, a definitive statement is collected. The definitive statement is identified from the organization policy (S210). In some embodiments, the relevant paragraph of the definitive statement may be collected together with the definitive statement. The definitive statement includes an actionable and monitorable practice or procedure to fulfill the control or guideline of the policy that the definitive statement is from.

At S420, groups of evidence data are collected. One or more groups of evidence data are searched and retrieved from the datastores (e.g., the datastores 140, FIG. 1) as described in S230. The one or more groups of evidence data are selected as being associated and relevant to the definitive statement. It should be noted that the group of evidence data are evidence data from the organization and its user systems of the organization policy.

At S430, additional context is determined. The additional context is determined with respect to the definitive statement, the group of evidence data, policy data, organization data, and the like, and any combination thereof. The context may include instructions, background, positive examples, negative examples, and the like, any combination thereof.

At S440, a compliance prompt is generated based on the collected input data. The collected input data may be the group of evidence data (S410), the definitive statement (S420), and the additional context (S430). The collected input data are added to the compliance prompt. It should be noted that the collection of input data (S410-S430) may be performed in a different order or in parallel without departing the scope of the disclosure.

At S450, the compliance prompt is fed to a query model. The query model is at least one language model (e.g., the query model 132, FIG. 1) that is applied to the prompt. In an embodiment, the compliance prompt is a specified prompt that has sufficient guidance for generating a query for unstructured and/or semi-structured evidence data. It should be noted that the prompt itself has unstructured data such as the definitive statement and the group of evidence data that cannot be readily processed.

In an example embodiment, the query model may be a generally trained language model. In another example embodiment, the query model is a fine-tuned language model based on examples datasets. In yet another example embodiment, the query model is a specially trained language model for generating the compliance query with respect to, for example, the organization, the evidence data, one or more controls, the policy, and the like, any combination thereof.

At S460, a compliance query is output. In an embodiment, the compliance query is generated in a unique context-based query that allows efficient retrieval of complaint evidence data from the one or more groups of evidence data. The context-based query does not rely on a fixed schema relationships which does not exist in the datastores of the evidence data. To this end, the context-based compliance query is capable of searching the unstructured evidence data with high efficiency and accuracy. In an embodiment, the output compliance query may be in a unique context-based query language. It should be noted that an evidence table or a group of evidence table (identified by evidence IDs) are arranged in different formats and thus, unique compliance queries are generated for each of these evidence tables even for the same definitive sentence. In an embodiment, a confidence score may be generated for the output compliance query. As an example, the confidence score from 1 to 0 defines a certainty or likelihood of correctness from high confidence to low confidence, respectively.

In an embodiment, the generated query may be stored in a memory and/or datastore (e.g., the datastores 140, FIG. 1) and at least some defined as a predetermined query. In a further embodiment, the generated query may be compared to the predetermined query that was previously generated and confirmed. The confidence score of the generated query may be adjusted based on the comparison. As an example, the confidence score is increased upon matching the generated query with the predetermined query and decreased when no match is identified. The predetermined query may be determined for an organization for their environment.

In some embodiments, the output compliance query and predetermined query are matched. Upon matching, the predetermined query is selected as the compliance query for the definitive statement. A mismatch between the generated query and the predetermined query suggests that the control described in the relevant paragraph is a new control that has not been predetermined. In such a scenario, the generated query is selected for searching the evidence data for the definitive statement in the datastore.

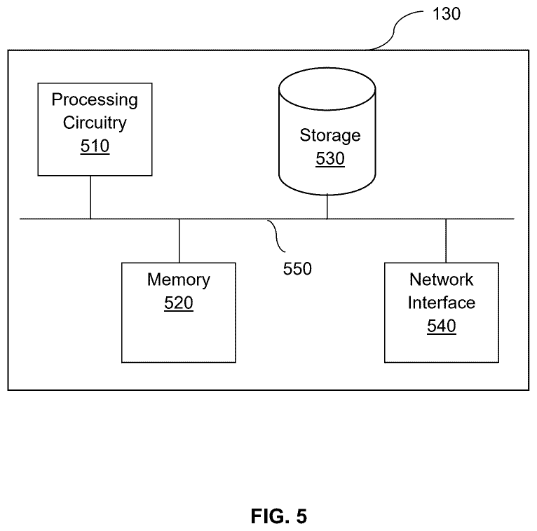

FIG. 5 is an example schematic diagram of a compliance system 130 according to an embodiment. The compliance system 130 includes a processing circuitry 510 coupled to a memory 520, a storage 530, and a network interface 540. In an embodiment, the components of the compliance system 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 540 allows the compliance system 130 to communicate with other systems, devices, components, applications, or other hardware or software components, for example as described herein.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for dynamic monitoring of compliance of practices of an organization with an organization policy, comprising:
parsing, via a policy language model, an organization policy document to determine a definitive statement that includes a natural language description of a practice that, when performed by the organization, satisfies compliance with a control of the organization policy;
generating, via a query model, a search query used to query a datastore of heterogenous evidence data for a group of evidence data that includes indicators of whether the organization performs the practice described in the definitive statement, wherein query language guidelines of the query model instruct the query model to generate the search query such that the search query does not rely on any schema of the datastore;
executing, via the query model, the search query to identify the group of evidence data;
generating, via the query model, a compliance query to query the group of evidence data, wherein the compliance query is a context-based query that is unique to the group of evidence data and the definitive statement, and wherein the compliance query is agnostic to any schema of the datastore;
executing, via the query model, the compliance query on the group of evidence data to detect whether the evidence data indicates that the organization performs the practice described in the definitive statement;
when the evidence data indicates that the organization performs the practice described in the definitive statement, reporting a compliance status of the organization as compliant with the definitive statement of the organization policy; and
when the evidence data does not indicate that the organization performs the practice described in the definitive statement, reporting the compliance status of the organization as noncompliant with the definitive statement of the organization policy.

2. The method of claim 1, further comprising:
causing a display of the compliance status at a user device.

3. The method of claim 2, wherein the display is a notification that has the compliance status and the definitive statement.

4. (canceled)

5. The method of claim 1, further comprising:
generating a compliance prompt to be fed to the query model, wherein the compliance prompt includes the definitive statement, the group of evidence data, context, and examples.

6. The method of claim 1, further comprising:
automatically retrieving the organization policy from the datastore, wherein the retrieving is initiated by at least one of: a periodical time interval, a demand, and a trigger.

7. (canceled)

8. The method of claim 1, wherein the search query used to query is generated based on a search prompt that includes the definitive statement, context, and examples.

9. The method of claim 1, wherein the query model is any one of: a general language model, a fine-tuned language model, a domain-specific language model, and a task-specific language model.

10. A non-transitory computer readable medium having stored thereon instructions for dynamic monitoring of compliance of practices of an organization with an organization policy, the instructions when executed by one or more processors, cause the one or more processors to:
parse, via a policy language model, an organization policy document to determine a definitive statement that includes a natural language description of a practice that, when performed by the organization, satisfies compliance with a control of the organization policy;
generate, via a query model, a search query used to query a datastore of heterogenous evidence data for a group of evidence data that includes indicators of whether the organization performs the practice described in the definitive statement, wherein query language guidelines of the query model instruct the query model to generate the search query such that the search query does not rely on any schema of the datastore;
execute, via the query model, the search query to identify the group of evidence data;
generate, via the query model, a compliance query to query the group of evidence data, wherein the compliance query is a context-based query that is unique to the group of evidence data and the definitive statement, and wherein the compliance query is agnostic to any schema of the datastore;
execute, via the query model, the compliance query on the group of evidence data to detect whether the evidence data indicates that the organization performs the practice described in the definitive statement;
when the evidence data indicates that the organization performs the practice described in the definitive statement, report a compliance status of the organization as compliant with the definitive statement of the organization policy; and
when the evidence data does not indicate that the organization performs the practice described in the definitive statement, report the compliance status of the organization as noncompliant with the definitive statement of the organization policy.

11. A system for dynamic monitoring of compliance of practices of an organization with an organization policy, comprising:
a processing circuitry; and
a memory, the memory containing instructions that, when executed by the processing circuitry, cause the system to:
parse, via a policy language model, an organization policy document to determine a definitive statement that includes a natural language description of a practice that, when performed by the organization, satisfies compliance with a control of the organization policy;
generate, via a query model, a search query used to query a datastore of heterogenous evidence data for a group of evidence data that includes indicators of whether the organization performs the practice described in the definitive statement, wherein query language guidelines of the query model instruct the query model to generate the search query such that the search query does not rely on any schema of the datastore;
execute, via the query model, the search query to identify the group of evidence data;
generate, via the query model, a compliance query to query the group of evidence data, wherein the compliance query is a context-based query that is unique to the group of evidence data and the definitive statement, and wherein the compliance query is agnostic to any schema of the datastore;
execute, via the query model, the compliance query on the group of evidence data to detect whether the evidence data indicates that the organization performs the practice described in the definitive statement;
when the evidence data indicates that the organization performs the practice described in the definitive statement, report a compliance status of the organization as compliant with the definitive statement of the organization policy; and
when the evidence data does not indicate that the organization performs the practice described in the definitive statement, report the compliance status of the organization as noncompliant with the definitive statement of the organization policy.

12. The system of claim 11, wherein the system is configured to:
cause a display of the compliance status at a user device.

13. The system of claim 12, wherein the display is a notification that has the compliance status and the definitive statement.

14. (canceled)

15. The system of claim 11, wherein the system is configured to:
generate a compliance prompt to be fed to the query model, wherein the compliance prompt includes the definitive statement, the group of evidence data, context, and examples.

16. The system of claim 11, wherein the system is configured to:
automatically retrieve the organization policy from the datastore, wherein the retrieving is initiated by at least one of: a periodical time interval, a demand, and a trigger.

17. (canceled)

18. The system of claim 11, wherein the search query used to query the datastore of heterogenous evidence data is generated based on a search prompt that includes the definitive statement, context, and examples.

19. The system of claim 11, wherein the query model is any one of: a general language model, a fine-tuned language model, a domain-specific language model, and a task-specific language model.
